(19) United States
(12) Patent Application Publication
(10) Pub. No.: US 2025/0317799 A1
(43) Pub. Date: Oct. 9, 2025

(54) RAN Centralization With Network Agility

(71) Applicant: Parallel Wireless, Inc., Nashua, NH (US)

(72) Inventor: Ofir Ben Ari Katzav, Zur Itshak (IL)

(21) Appl. No.: 18/969,698

(22) Filed: Dec. 5, 2024

Related U.S. Application Data
(63) Continuation of application No. 18/582,475, filed on Feb. 20, 2024.
(60) Provisional application No. 63/484,485, filed on Feb. 11, 2023.
(60) Provisional application No. 63/485,790, filed on Feb. 17, 2023.
(60) Provisional application No. 63/487,245, filed on Feb. 27, 2023.
(60) Provisional application No. 63/493,599, filed on Mar. 31, 2023.
(60) Provisional application No. 63/499,239, filed on Apr. 30, 2023.
(60) Provisional application No. 63/606,092, filed on Dec. 4, 2023.
(60) Provisional application No. 63/551,873, filed on Feb. 22, 2024.

(51) Int. Cl. H04W 28/08; H04W 28/02

(52) U.S. Cl. CPC H04W 28/08; H04W 28/0284; H04W 28/0289

(57) ABSTRACT

A method is disclosed for network agility traffic steering at a centralized management entity in a network system, the method comprising: receiving load management information from a plurality of cells within a network cluster; evaluating the load management information to determine resource allocation for the plurality of cells within the network cluster; generating traffic steering instructions based on the evaluation; transmitting the traffic steering instructions to the cells within the network cluster to dynamically adjust resource allocation and network performance; and enabling clustering of cells through containerized microservices coordinated using Kubernetes, allowing for flexible and scalable deployment of network functions.

### CROSS-REFERENCE TO RELATED APPLICATIONS

This application claims the benefit of priority under 35 U.S.C. § 119(e) and/or PCT Article 8 to U.S. Provisional Application Nos. 63/606,092 and 63/551,873, each titled “RAN Centralization with Network Agility” and filed on Dec. 4, 2023 and Feb. 22, 2024, respectively, which are also each incorporated by reference in their entireties for all purposes. Additionally, the present application incorporates by reference U.S. Pat. App. Nos. 63/499,239, 63/493,599, 63/485,790, 63/487,245, and 63/484,485 in their entirety for all purposes. In addition, U.S. Pat. App. Nos. US20230269633A1 and US20230291646A1 are hereby incorporated by reference in their entirety for all purposes.

### SUMMARY

A method for network agility traffic steering at a centralized management entity in a network system, the method comprising: receiving load management information from a plurality of cells within a network cluster; evaluating the load management information to determine resource allocation for the plurality of cells within the network cluster; generating traffic steering instructions based on the evaluation; transmitting the traffic steering instructions to the cells within the network cluster to dynamically adjust resource allocation and network performance; and enabling clustering of cells through containerized microservices coordinated using Kubernetes, allowing for flexible and scalable deployment of network functions.

The network cluster may be configured to utilize low-latency backhaul connections, such as eCPRI, to ensure rapid communication between the centralized management entity and the cells within the cluster. The centralized management entity may take into account the signal strength of the different cells as seen from user equipment (UE) to enhance the accuracy of traffic steering decisions. The centralized management entity may be implemented using a near-real-time RAN Intelligent Controller (RIC) capable of handling multi-RAT environments. The centralized management entity may provide network agility traffic steering in a multi-RAT (Radio Access Technology) environment. The cells may operate on different RATs including at least 4G and 5G. The instructions may be applicable to at least two of Option 7.2, Option 6, and Option 8 radio fronthaul splits. The centralized management entity may perform decision-making that takes into account energy savings by steering traffic to a smaller number of carriers, thereby reducing the number of active carriers at a given time. The centralized management entity may provide resource allocation for at least two of 2G, 4G, and 5G. The network system may perform proactive load balancing by rebalancing an entire cluster when a certain load threshold may be reached, rather than waiting for a single cell to reach its maximum load. The network system may integrate AI/ML policies and enrichment across different generations (Gs) to optimize network performance. The network system may use a microservices-based architecture for high availability and scalability, enabling parallel processing and advanced monitoring.

### BRIEF DESCRIPTION OF THE DRAWINGS

FIG. 1 is a schematic drawing of a cellular network, in accordance with the prior art.

FIG. 2 is a schematic drawing of a cellular network, in accordance with some embodiments.

FIG. 3 is a schematic drawing of a large cellular network separated into clusters, in accordance with some embodiments.

FIG. 4 is a further schematic drawing of a cellular network separated into clusters, in accordance with some embodiments.

FIG. 5 is a further schematic drawing of a cellular network separated into clusters, in accordance with some embodiments.

FIG. 6 is a schematic drawing of a cellular network reacting to a load situation, in accordance with the prior art.

FIG. 7 is a schematic drawing of a cellular network reacting to a load situation, in accordance with some embodiments.

FIG. 8 is a further schematic drawing of a cellular network reacting to a load situation, in accordance with some embodiments.

FIG. 9 is a further schematic drawing of a cellular network reacting to a load situation, using rebalancing to create increased capacity to enable multi-site carrier aggregation, in case of a given UE designated as eligible for more throughput, in accordance with some embodiments.

FIG. 10 is a schematic diagram of a legacy RAN deployment architecture, as known in the prior art.

FIG. 11 is a schematic diagram of 3GPP functional splits, as known in the prior art.

FIG. 12 is a schematic diagram of an Open RAN 4G/5G deployment architecture, as known in the prior art.

FIG. 13 is a first schematic diagram of a multi-RAT RAN deployment architecture, in accordance with some embodiments.

FIG. 14 is a second schematic diagram of a multi-RAT RAN deployment architecture, in accordance with some embodiments.

FIG. 15 is a third schematic diagram of a multi-RAT RAN deployment architecture, in accordance with some embodiments.

FIG. 16 is a fourth schematic diagram of a multi-RAT RAN deployment architecture, in accordance with some embodiments.

FIG. 17 is a fifth schematic diagram of a multi-RAT RAN deployment architecture, in accordance with some embodiments.

FIG. 18 is a schematic diagram of a multi-RAT RAN deployment in operation, in accordance with some embodiments.

FIG. 19 is a schematic diagram of an OpenRAN core architecture, in accordance with some embodiments.

FIG. 20 is a schematic diagram of a 5G core, in accordance with some embodiments.

FIG. 21 is a schematic diagram of a CU-CP namespace, in accordance with some embodiments.

FIG. 22 is a schematic diagram of a microservice control architecture, in accordance with some embodiments.

FIG. 23 is a schematic diagram of an SCTP microservice, in accordance with some embodiments.

### DETAILED DESCRIPTION

Traffic Steering between two cells is known in the art. Traffic steering differs from admission control, although admission control is load balancing in a way, in that traffic steering involves redirecting UEs after they have attached to the network, whereas admission control involves rejecting UEs before they have attached to the network. Briefly, traffic steering involves transitioning a device from a first frequency to a second frequency, or from a first radio access technology (RAT) to a second RAT, or from a first network slice to another network slice, etc., without the device necessarily changing its physical location. Traffic steering works in conjunction with mobility (e.g., handover) to ensure seamless connectivity for a UE in motion and at rest, while it is in multiple operational states.

For example, in regular traffic steering, if a given UE is dragging the performance of a given cell down, traffic steering involves sending a message to steer that UE to go to another cell. This frees up the spectrum that was used by that UE. In many cases this helps a lot because that UE probably had a bad link, in which case this UE is likely to have been using a lot of spectrum. The traffic is now going from the new cell (because the traffic follows the UE), and in some cases, the UE is closer to the new cell by distance anyway. Further, the original cell gets freed up spectrum, which provides a quite huge improvement for any user on the original cell.

Advanced traffic steering in 5G is even more a part of our everyday lives, as 5G frequencies include high, mid, and low frequency bands that have significant differences in terms of coverage and capacity, with concomitant differences in their utility and applicability to different usage scenarios. 5G cells also have primary and secondary cells with dual connectivity, as well as carrier aggregation for enabling multiple carriers to be used for a given UE; each of these can also benefit from 5G traffic steering to steer (change attachment cell) for a given UE.

This works for almost any two cells. Steering is based on a range evaluation using UE measurements. However, traffic steering at a cluster level, where the target cell for traffic steering is evaluated in the context of a cluster of cells, is new. Steering is possible in this new paradigm not only to the next neighbor cell, but to second-and third-order neighbors, in some embodiments. This is called network agility traffic steering in the context of this disclosure.

In network agility traffic steering, a centralized management entity performs decision making of which UEs should use which resources throughout the cluster, taking into account load management information for the whole cluster, not just for the individual cells where steering is taking place, including load management for different frequency bands, carriers, RATs, etc. The centralized management entity also takes into account the location of the UE or at least the signal strength of the different cells as seen from the UE. The centralized management entity receives steering messages from the cells, performs assessments, and then sends messages to the cells, which are then caused to enact the centralized management entity's steering decisions by sending the appropriate traffic steering messages.

In some embodiments, a Near-RT RIC is used for management. In some embodiments, the near-RT RIC is an all-G/multi-RAT near-RT RIC, capable of handling at least 4G and 5G, and in some cases 2G/4G/5G or 2G/3G/4G/5G. This works for any 5G RRH functional split as well (e.g., Option 7.2, Option 6, Option 8). Can work for centralized or non-centralized latency networks as well.

In some embodiments, the centralized management entity performs decision making taking into account energy savings. For example, by steering traffic to a smaller number of carriers, it is possible to reduce the number of active carriers at a given time, with a large impact on power savings. This applies to RATs, frequencies, etc. as well. In some embodiments, various heuristics and algorithms, for example, those described in U.S. Pat. 10420170 (hereby incorporated by reference), could be used for reducing power.

As background, typical mobile operator networks are statically configured, and dynamic changes to the network are made to individual sectors or carriers, but not typically propagated to other divisions in the network. Traffic steering is a form of load balancing that is known in the prior art. In some cases, traffic steering involves directing a UE to move from one base station/carrier/frequency layer to another based on a traffic-related heuristic. However, it is complex to configure prior art networks to automatically perform load balancing in a holistic manner. More information about traffic steering is found below and in 3GPP TS 29.144, hereby incorporated by reference in its entirety for all purposes.

In the present application, certain ideas associated with centralization of RAN functions are adapted to enable load balancing throughout the network. This concept is called network agility. Instead of a statically configured network, an ideal network solution would have flexibility and adaptability while being able to maximize network resources. This is achieved by enabling the network to quickly adjust to network changes and to efficiently allocate cluster resources, in addition to resources of individual base stations or radios.

Certain embodiments of the present application involve the use of RAN centralization technology, e.g., technology that enables management and control of resources within an entire cluster from a single location in the network. This may be embodied in a cluster management system that takes the place of a plurality of multiple baseband units (BBUs) without coordination. This is an efficient use of physical resources as in the prior art, multiple BBUs may be physically housed in a single data center or data cabinet. By adding an intelligent coordination layer and by adding application programming interfaces (APIs) and other interfaces on top of these already-present resources, a dynamic, proactive management system is enabled.

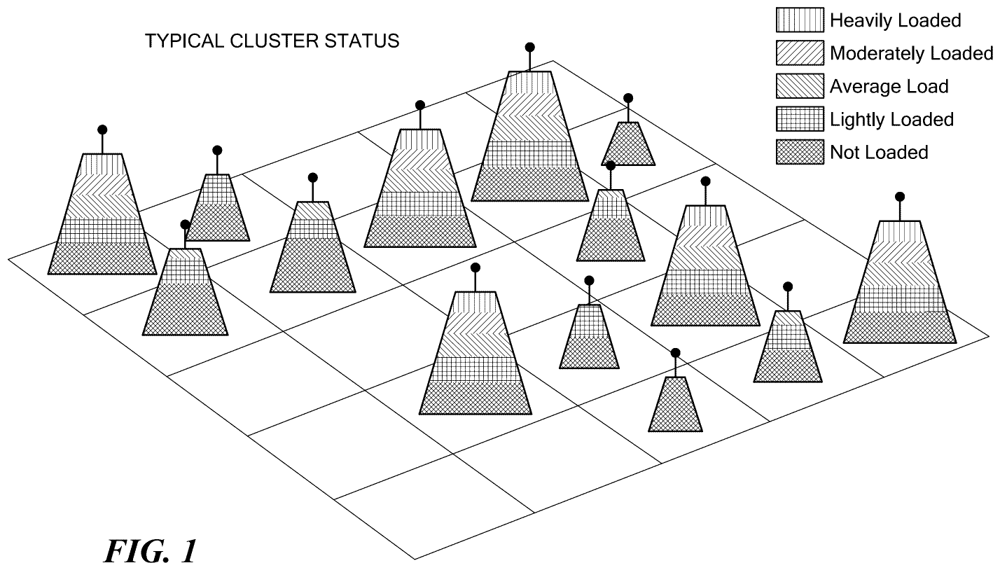

FIG. 1 is a schematic drawing of a cellular network, in accordance with the prior art. While multiple cells are physically close to each other and may be intended to be managed as a cluster, the cluster still contains certain cells that are more heavily loaded than others. FIG. 1 uses different grayscale patterns to show load, with size of each cell shown by the visual size of the icon representing the radio.

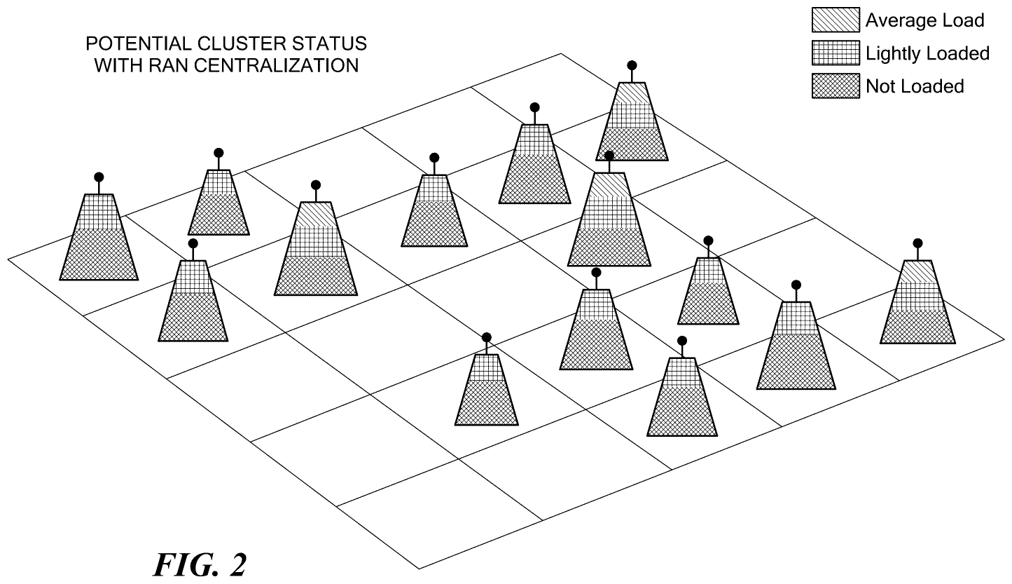

FIG. 2 is a schematic drawing of a cellular network, in accordance with some embodiments. This figure shows active management of a cluster in such a way that each cell throughout the network is more evenly loaded.

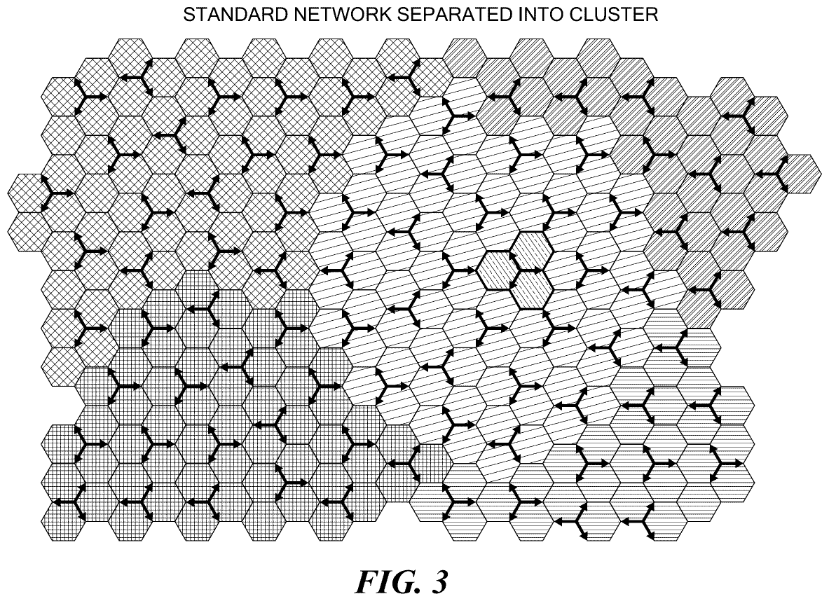

FIG. 3 is a schematic drawing of a large cellular network separated into clusters, in accordance with some embodiments. Contiguous cells are separated into clusters.

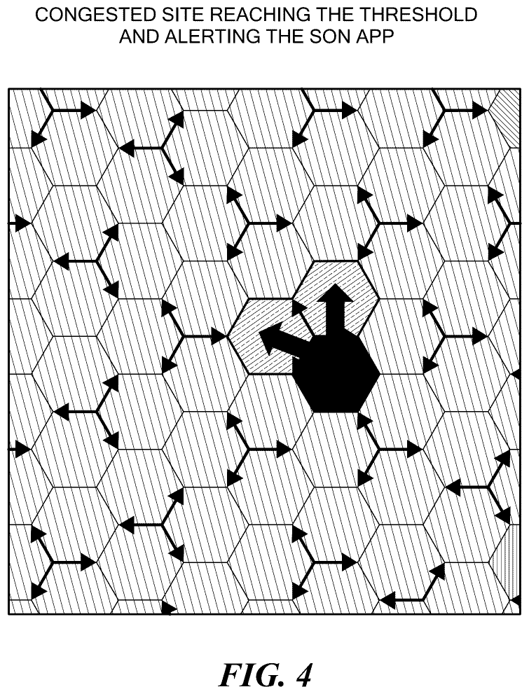

FIG. 4 is a further schematic drawing of a cellular network separated into clusters, in accordance with some embodiments. A congested site reaches a usage threshold and an alert is triggered for a self-organizing network application. Traffic steering is performed, which is not admission control but load balancing, e.g., if a given UE asks for more throughput, or if a given UE is dragging the cell down, how about steering that UE to go to another cell. This frees up the spectrum that was used by that UE. In many cases this helps a lot because that UE probably had a bad link and was using a lot of spectrum. The traffic is now going from the new cell because the traffic follows the UE. The original cell gets freed up spectrum, which provides a quite large improvement for almost any two cells. We know UE is in range because you have UE measurements.

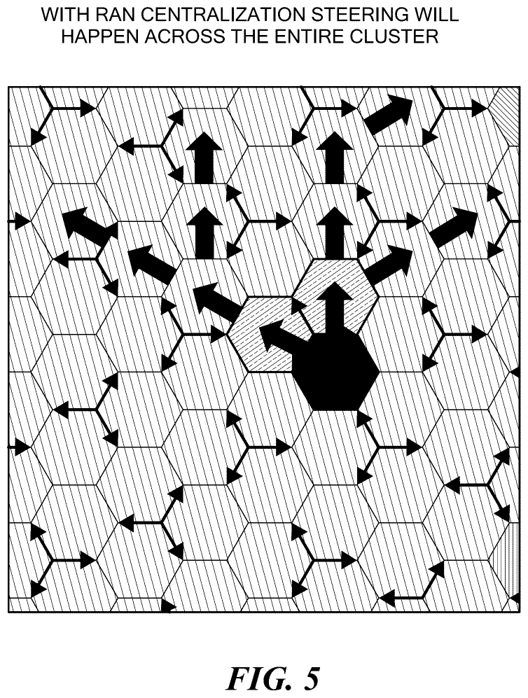

FIG. 5 is a further schematic drawing of a cellular network separated into clusters, in accordance with some embodiments. The previous figure is extended by showing traffic steering at a cluster level, not only Not only to the next neighbor cell, but to second-and third-order neighbors. This results in rebalancing the entire cluster. This may be performed at the Near-RT RIC. The app may appropriately decide which UE to go where. This works for any radio access technology (e.g., 3G, 4G, 5G, etc.), any CU/DU functional split, centralized or non-centralized latency networks, etc. Implementation is performed in the RIC, in some embodiments.

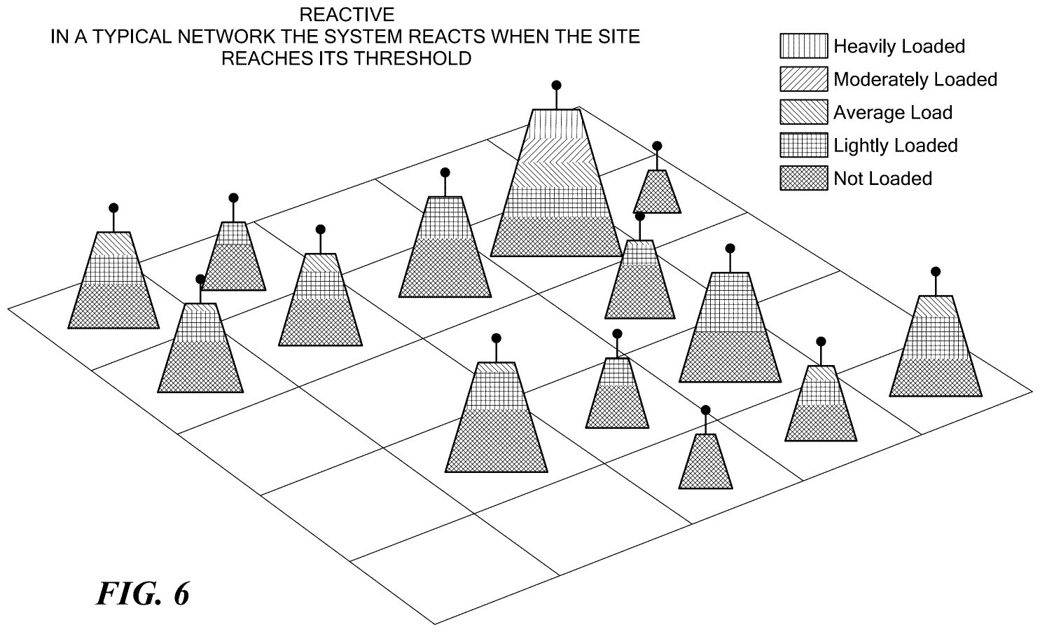

FIG. 6 is a schematic drawing of a cellular network reacting to a load situation, in accordance with the prior art. The figure shows a reactive system in which the system reacts only when a given site reaches its max load, typically by aggressively load-shedding from the heavily-loaded cell site.

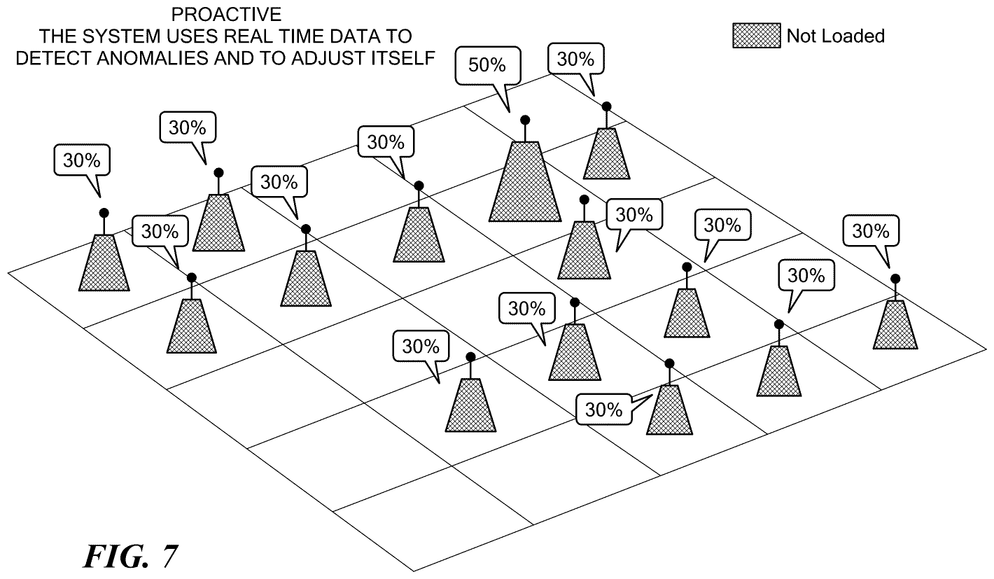

FIG. 7 is a schematic drawing of a cellular network reacting to a load situation, in accordance with some embodiments. Instead of waiting for a single cell to reach its maximum load, here, a 50% threshold is high enough to cause the entire cluster to rebalance itself via traffic steering.

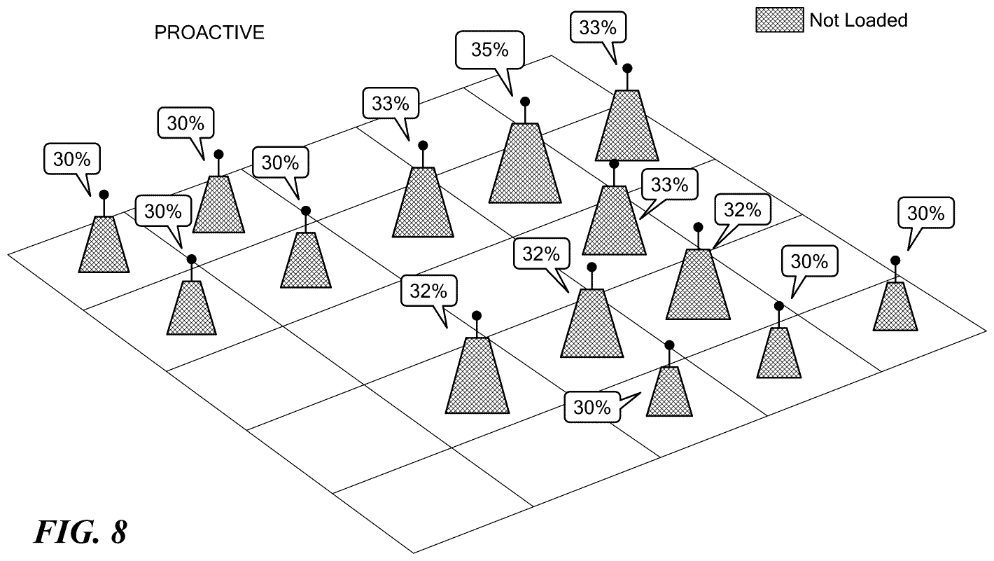

FIG. 8 is a further schematic drawing of a cellular network reacting to a load situation, in accordance with some embodiments. The present diagram shows a further example of a proactive rebalancing network.

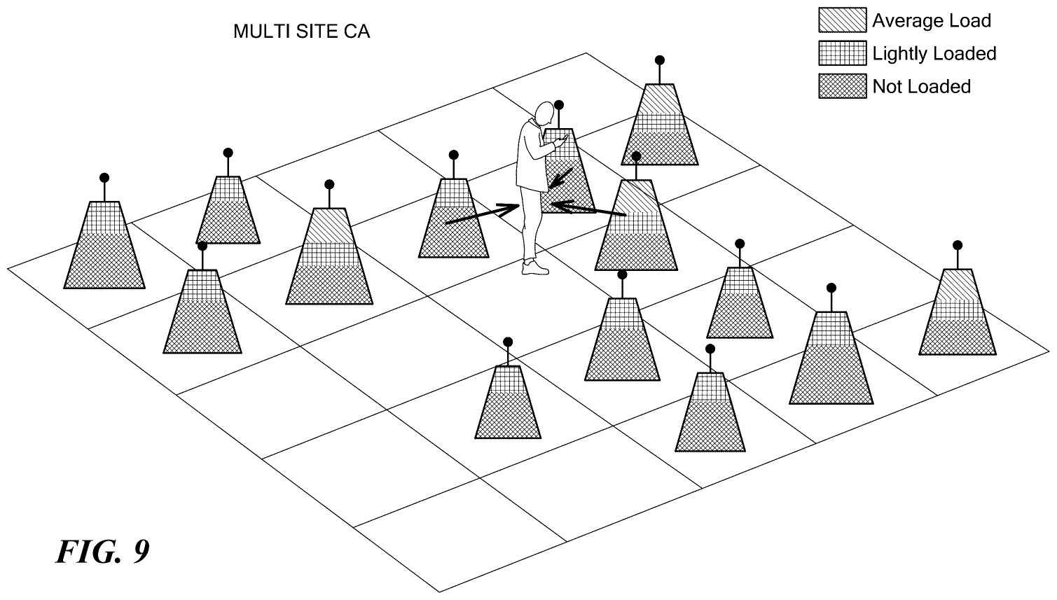

FIG. 9 is a further schematic drawing of a cellular network reacting to a load situation, using rebalancing to create increased capacity to enable multi-site carrier aggregation, in case of a given UE designated as eligible for more throughput, in accordance with some embodiments.

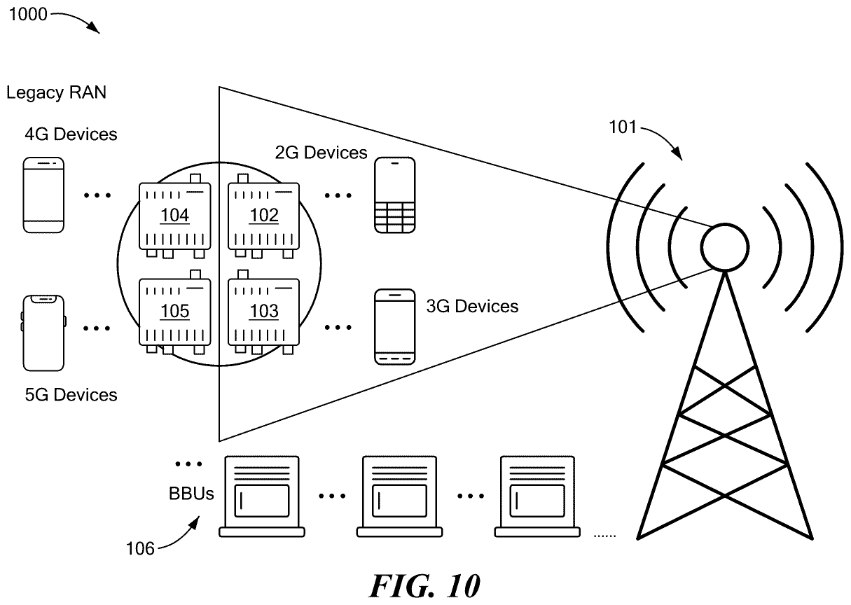

FIG. 10 is a schematic diagram of a legacy RAN deployment architecture, as known in the prior art.

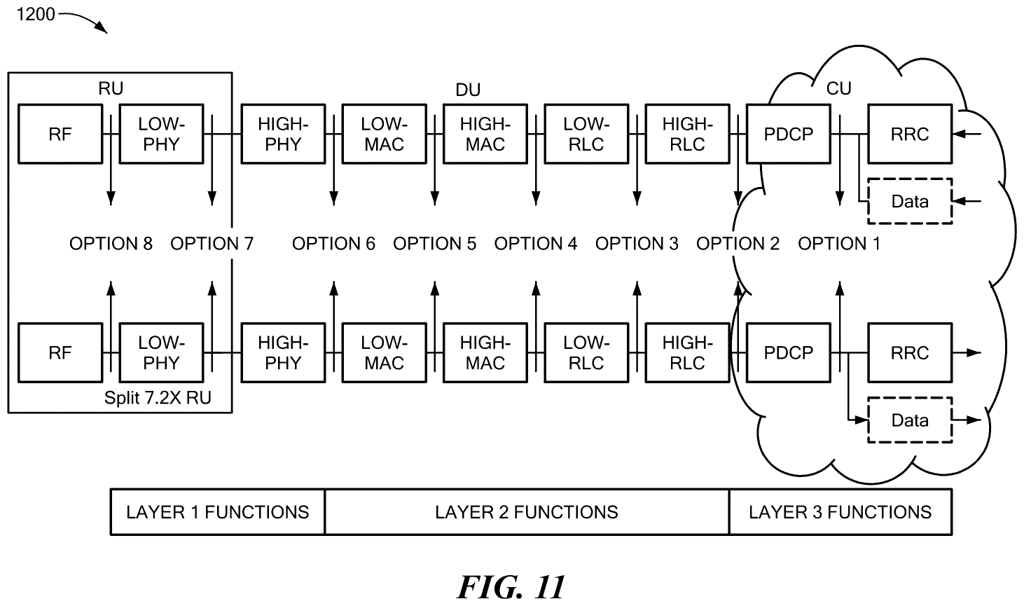

FIG. 11 is a schematic diagram of 3GPP functional splits, as known in the prior art.

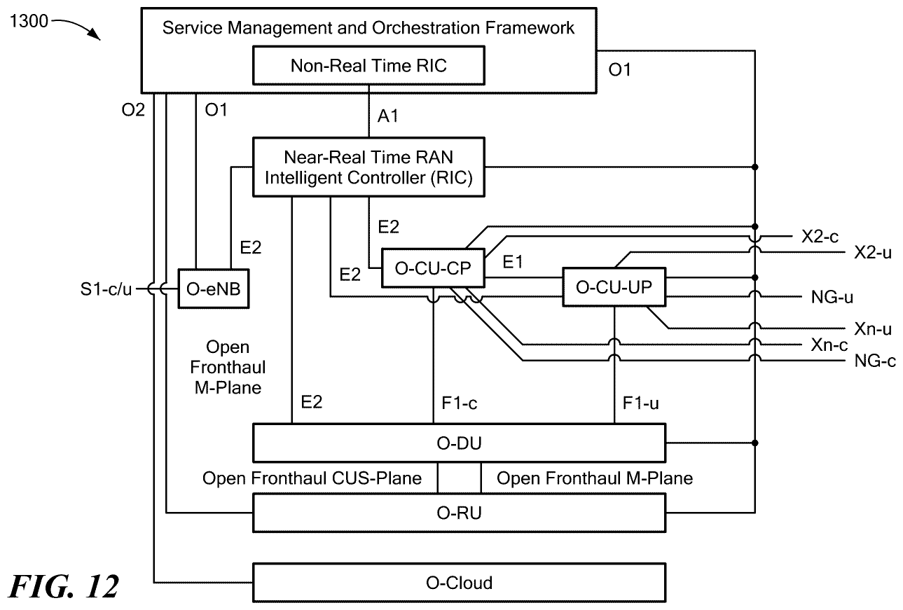

FIG. 12 is a schematic diagram of an Open RAN 4G/5G deployment architecture, as known in the prior art.

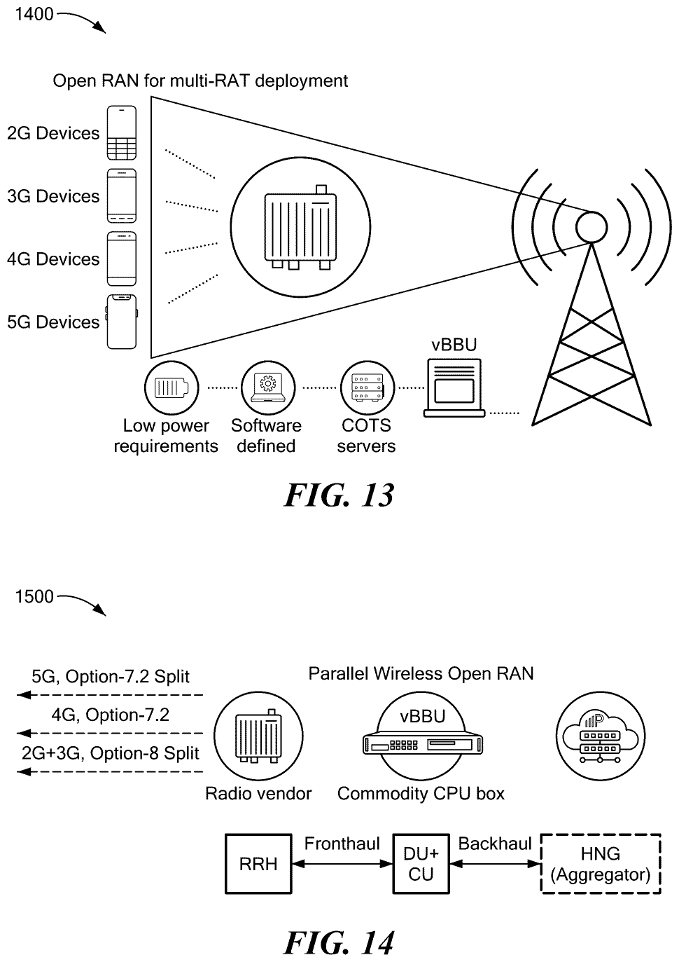

FIG. 13 is a first schematic diagram of a multi-RAT RAN deployment architecture, in accordance with some embodiments.

FIG. 14 is a second schematic diagram of a multi-RAT RAN deployment architecture, in accordance with some embodiments.

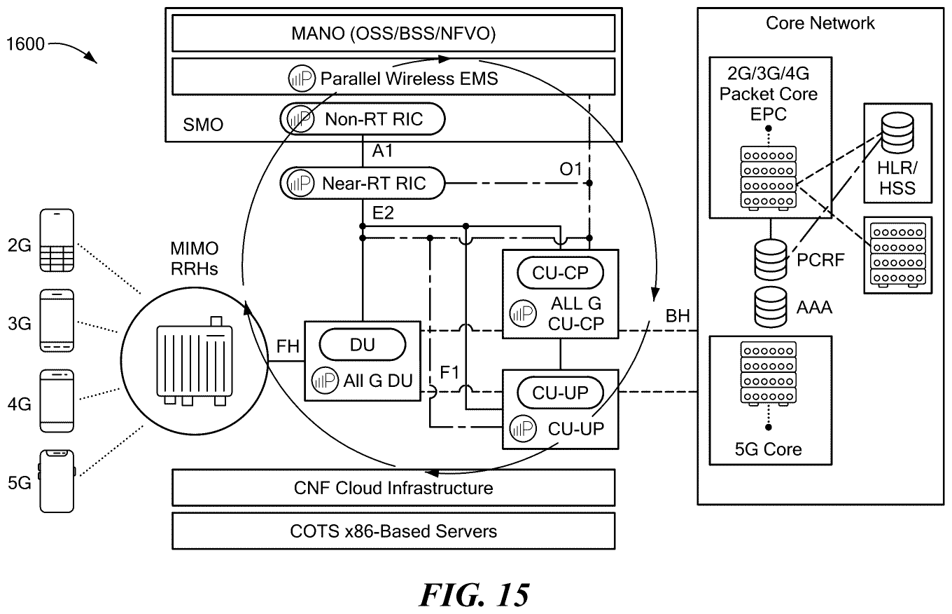

FIG. 15 is a third schematic diagram of a multi-RAT RAN deployment architecture, in accordance with some embodiments.

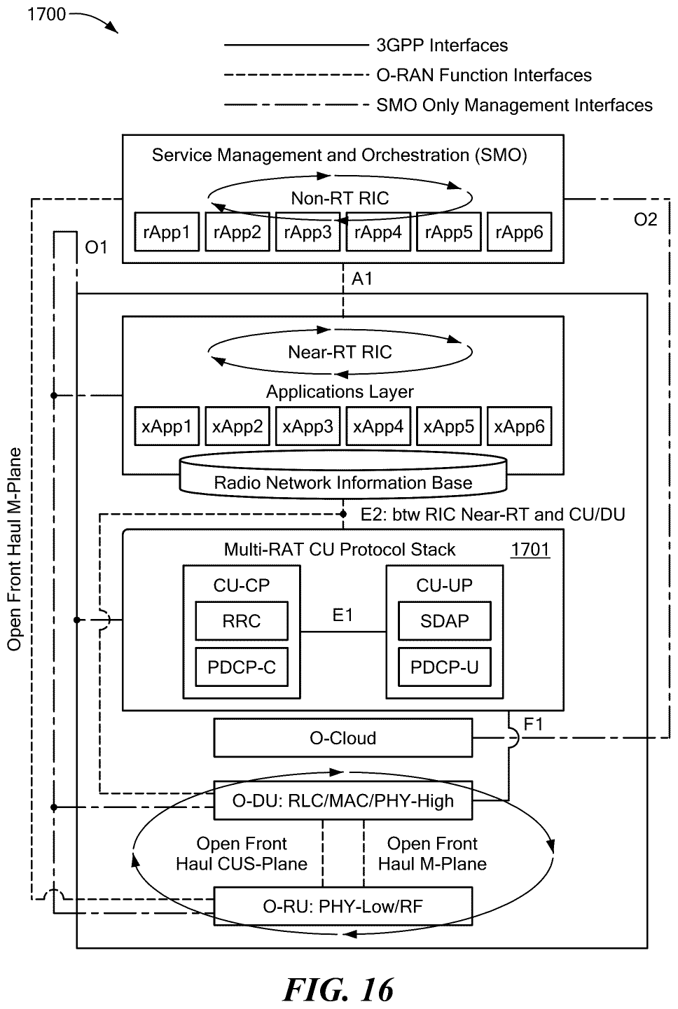

FIG. 16 is a fourth schematic diagram of a multi-RAT RAN deployment architecture, in accordance with some embodiments.

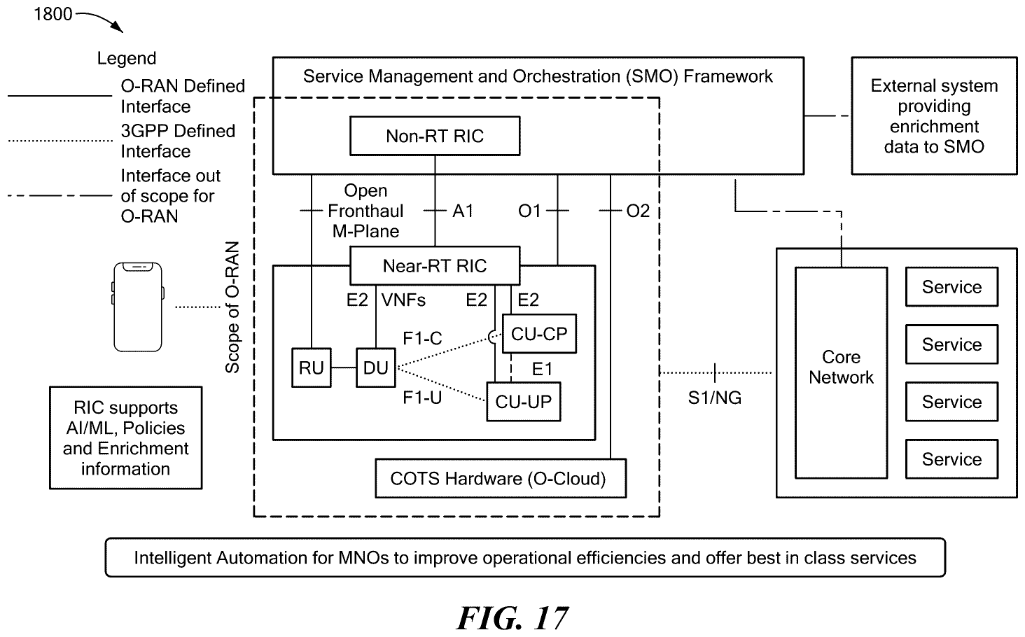

FIG. 17 is a fifth schematic diagram of a multi-RAT RAN deployment architecture, in accordance with some embodiments.

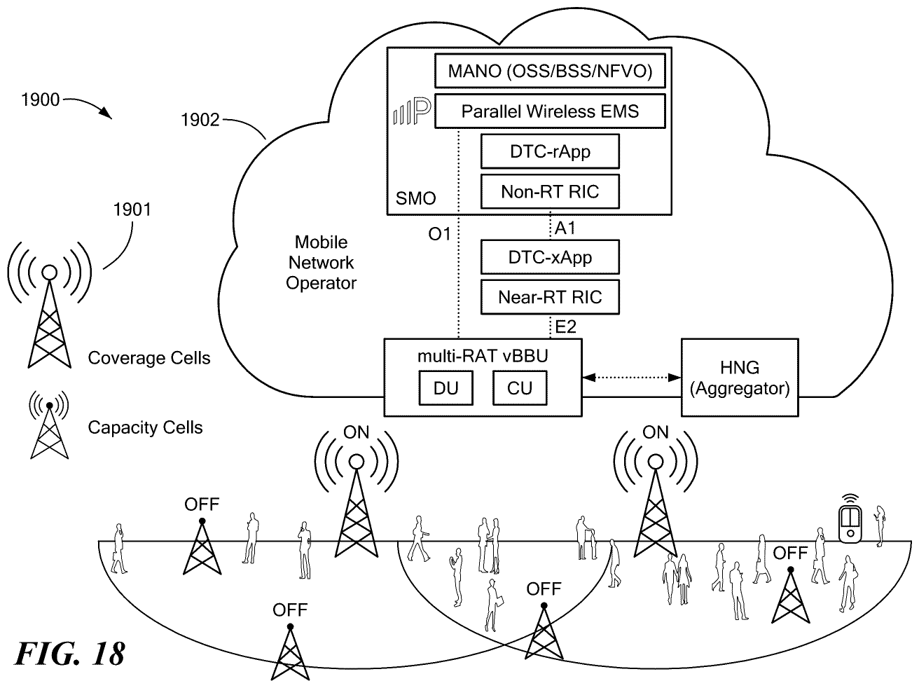

FIG. 18 is a schematic diagram of a multi-RAT RAN deployment in operation, in accordance with some embodiments.

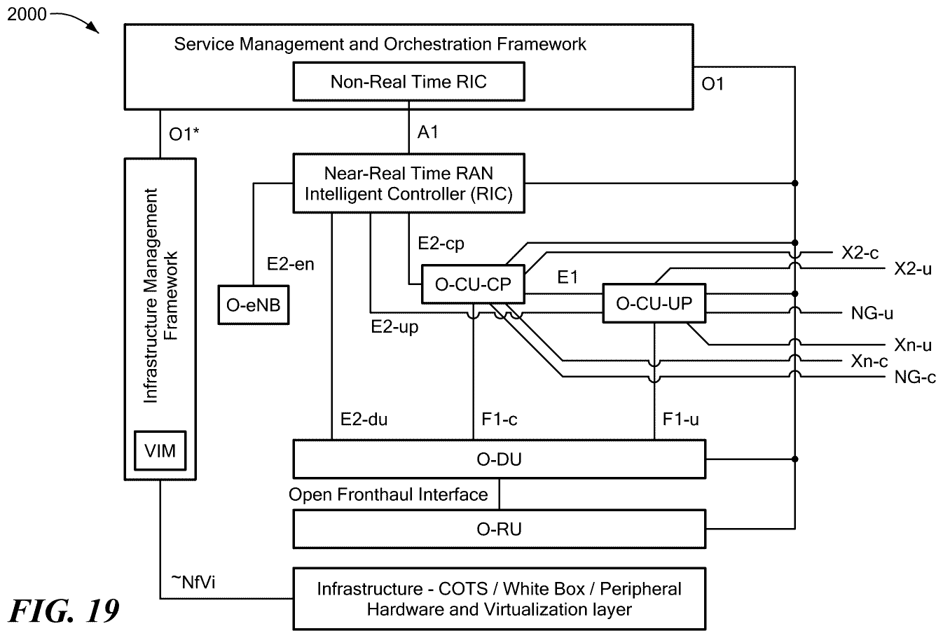

FIG. 19 is a schematic diagram of an OpenRAN core architecture, in accordance with some embodiments.

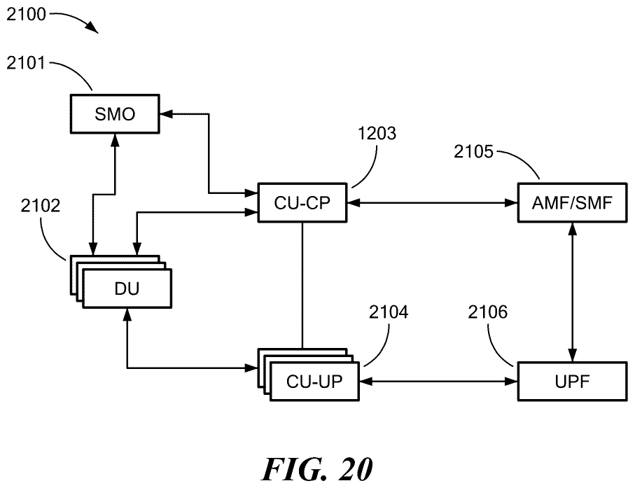

FIG. 20 is a schematic diagram of a 5G core, in accordance with some embodiments.

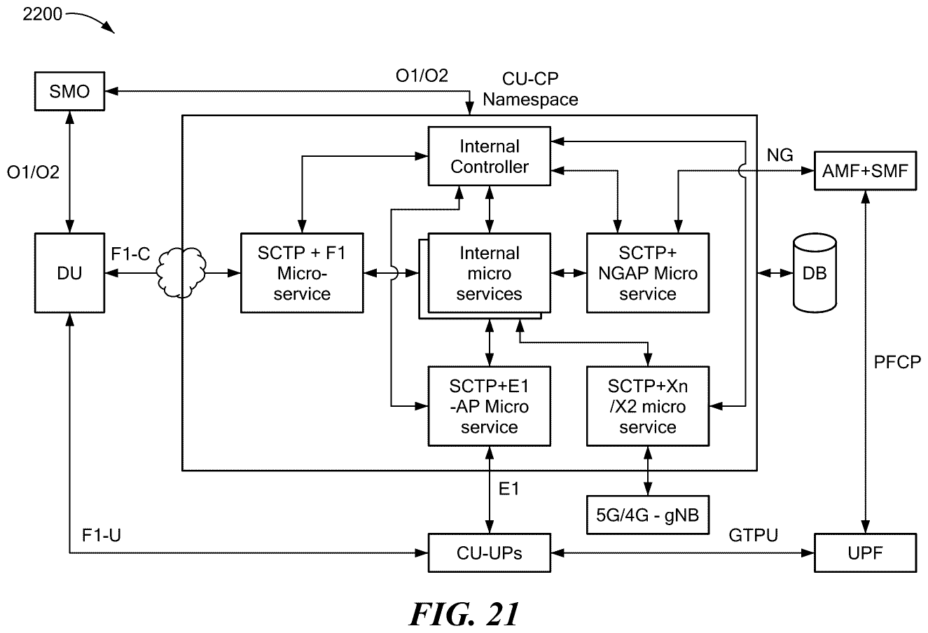

FIG. 21 is a schematic diagram of a CU-CP namespace, in accordance with some embodiments.

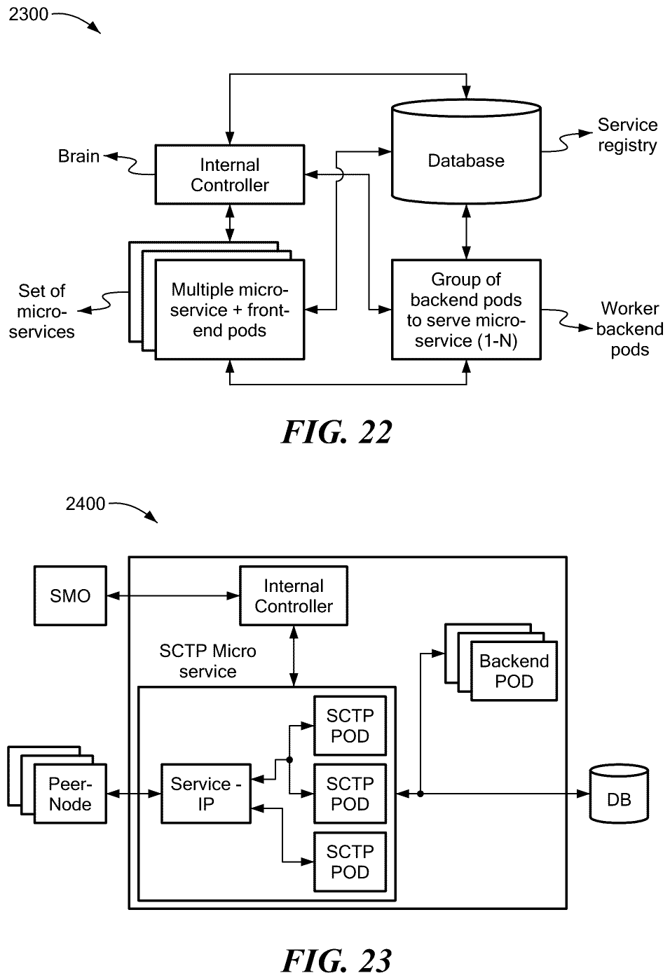

FIG. 22 is a schematic diagram of a microservice control architecture, in accordance with some embodiments.

FIG. 23 is a schematic diagram of an SCTP microservice, in accordance with some embodiments.

FIG. 10 is a schematic diagram of a legacy RAN deployment architecture, as known in the prior art. Radio tower 1101 is used for co-locating a 2G base station 1102, 3G base station 1103, 4G base station 1104, and 5G base station 1105, each individual RAT base station having its own radio(s) and processing. To support and enable the radios to perform their necessary functions, including PHY, MAC, backhaul, RRC, etc., several base band units (BBUs) 1106 are typically located at the base of the tower and are connected to the individual RAT base stations using a physical cable. This cable itself introduces signal loss and heat/power wastage. The BBUs themselves are expensive to purchase and deploy to the site, are expensive to operate given their need for real estate, HVAC and electrical support, and are expensive also to maintain, as a typical maintenance activity requires a dedicated truck roll to the site with a skilled technician.

FIG. 11 shows a schematic diagram of radio functional splits showing split 7.2X RU as well as other splits. The use of these functional splits is encouraged by ORAN.

5G New Radio (NR) was designed to allow for disaggregating the baseband unit (BBU) by breaking off functions beyond the Radio Unit (RU) into Distributed Units (DUs) and Centralized Units (CUs), which is called a functional split architecture. This concept has been extended to 4G as well.

RU: This is the radio hardware unit that coverts radio signals sent to and from the antenna into a digital signal for transmission over packet networks. It handles the digital front end (DFE) and the lower PHY layer, as well as the digital beamforming functionality. 5G RU designs are supposed to be inherently intelligent, but the key considerations of RU design are size, weight, and power consumption. Deployed on site.

DU: The distributed unit software that is deployed on site on a COTS server. DU software is normally deployed close to the RU on site and it runs the RLC, MAC, and parts of the PHY layer. This logical node includes a subset of the eNodeB (eNB)/gNodeB (gNB) functions, depending on the functional split option, and its operation is controlled by the CU.

CU: The centralized unit software that runs the Radio Resource Control (RRC) and Packet Data Convergence Protocol (PDCP) layers. The gNB consists of a CU and one DU connected to the CU via Fs-C and Fs-U interfaces for CP and UP respectively. A CU with multiple DUs will support multiple gNBs. The split architecture lets a 5G network utilize different distributions of protocol stacks between CU and DUs depending on midhaul availability and network design. It is a logical node that includes the gNB functions like transfer of user data, mobility control, RAN sharing (MORAN), positioning, session management etc., except for functions that are allocated exclusively to the DU. The CU controls the operation of several DUs over the midhaul interface. CU software can be co-located with DU software on the same server on site.

When the RAN functional split architecture (FIG. 14) is fully virtualized, CU and DU functions runs as virtual software functions on standard commercial off-the-shelf (COTS) hardware and be deployed in any RAN tiered datacenter, limited by bandwidth and latency constraints.

Option 7.2 (shown) is the functional split chosen by the O-RAN Alliance for 4G and 5G. It is a low-level split for ultra-reliable low-latency communication (URLLC) and near-edge deployment. RU and DU are connected by the eCPRI interface with a latency of ˜100 microseconds. In O-RAN terminology, RU is denoted as O-RU and DU is denoted as O-DU. Further information is available in US20200128414A1, hereby incorporated by reference in its entirety.

FIG. 12 is a schematic diagram of an Open RAN 4G/5G deployment architecture, as known in the prior art. The O-RAN deployment architecture includes an O-DU and O-RU, as described above with respect to FIG. 12, which together comprise a 5G base station in the diagram as shown. The O-CU-CP (central unit control plane) and O-CU-UP (central unit user plane) are ORAN-aware 5G core network nodes. An ORAN-aware LTE node, O-eNB, is also shown. As well, a near-real time RAN intelligent controller is shown, in communication with the CU-UP, CU-CP, and DU, performing near-real time coordination As well, a non-real time RAN intelligent controller is shown, receiving inputs from throughout the network and specifically from the near-RT RIC and performing service management and orchestration (SMO), in coordination with the operator's network (not shown). Absent from the ORAN network concept is any integration of 2G, 3G. Also absent is any integration of a 2G/3G/4G DU or RU. The present application describes network agility; this is also missing from the ORAN network concept.

FIG. 13 is a first schematic diagram of a multi-RAT RAN deployment architecture, in accordance with some embodiments. FIG. 14 shows a radio tower with a remote radio head (RRH) supporting multiple RATs, 2G/3G/4G/5G, but without requiring four generations of radio base stations as shown in FIG. 11. Instead, one or more software-upgradable, remotely configurable base stations is coupled to radio heads and filters that are able to operate on the appropriate frequencies for 2G , 3G, 4G, and 5G RATs. The multiple BBUs located at the bottom of the tower in FIG. 11 have been replaced with one or more vBBUs, baseband units that are rearchitected to use modern virtualization technologies. FIG. 14 can be enabled using a technology like CPRI or eCPRI, which enables digitization and transfer of radio I/Q samples for further processing at a BBU or vBBU.

Where virtualization is described herein, one having skill in the cloud technology arts would understand that a variety of technologies could be used to provide virtualization, including one or more of the following: containers, Kubernetes, Docker, hypervisors, virtual machines, hardware virtualization, microservices, AWS, Azure, etc. In a preferred embodiment, containerized microservices coordinated using Kubernetes are used to provide baseband processing for multiple RATs as deployed on the tower.

The inventors have appreciated that the use of the 3GPP model for functional splits is flexible and may be used to provide deployment flexibility for multiple RATs, not just 5G. Functional splits can be used in conjunction with cloud and virtualization technology to perform virtualization of, e.g., the RU, DU, and CU of not just 5G but also 4G, 3G, 2G, etc. This enables the use of commodity off-the-shelf servers, software-defined networking that can be rapidly upgraded remotely, and lower power requirements by using modern hardware compared to legacy hardware.

FIG. 14 is a second schematic diagram of a multi-RAT RAN deployment architecture, in accordance with some embodiments. As shown, a single RRH supports a 5G RAT with an Option 7.2 split, a 4G RAT with an Option 7.2 split, and 2G+3G with an Option 8 split. With the Option 7.2 split, the PHY is split into High PHY and Low PHY. For option 7-2, the uplink (UL), CP removal, fast Fourier transform (FFT), digital beamforming (if applicable), and prefiltering (for PRACH (Physical Random Access Channel) only) functions all occur in the RU. The rest of the PHY is processed in the DU. For the downlink (DL), the inverse FFT (iFFT), CP addition, precoding functions, and digital beamforming (if applicable) occur in the RU, and the rest of the PHY processing happens in the DU. This is the preferred ORAN split for 5G, and can also be used for 4G. For 2G+3G, an Option 8 split is preferred, where only RF will be performed at the RU and further processing (PHY/MAC/RLC/PDCP) is performed at the vBBU. This is desirable because the processing and latency requirements for 2G and 3G are lower, and are readily fulfilled by a BBU or VBBU.

Continuing with FIG. 14, a fronthaul link connects the RRH to a DU+CU, which runs a variety of virtualized RAT processing on a vBBU machine. The fronthaul link may be CPRI or eCPRI, or another similar interface. The DU+CU may be located at the base of the tower or at a further remove as enabled by different latency envelopes; typically this will be close to the tower for a 5G deployment. In some embodiments, a HetNet Gateway (HNG), which performs control and user plane data aggregation and gateway services, may be the next destination via the backhaul connection; the HNG may disaggregate the different RAT communications to be directed to different RAT cores (i.e., a 2G core, a 3G core, a 4G core, a 5G core and so on). In some embodiments and in certain situations, an HNG may perform virtualization or interworking of aggregated communications such that, e.g., 2G communications may be interworked to 4G IP voice communications and routed through the 4G core. In some embodiments, the HNG may perform virtualization of one or more cores such that the communications may not need to terminate at a RAT-specific core; this feature may be combined with interworking in some embodiments. In some embodiments, no aggregator may be present and the vBBU may directly route communications to each RAT's individual core.

FIG. 15 is a third schematic diagram of a multi-RAT RAN deployment architecture, in accordance with some embodiments. Multiple generations of UE are shown, connecting to RRHs that are coupled via fronthaul to an all-G Parallel Wireless DU. The all-G DU is capable of interoperating with an all-G CU-CP and an all-G CU-UP. Backhaul may connect to the operator core network, in some embodiments, which may include a 2G/3G/4G packet core, EPC, HLR/HSS, PCRF, AAA, etc., and/or a 5G core. In some embodiments an all-G near-RT RIC is coupled to the all-G DU and all-G CU-UP and all-G CU-CP. Unlike in the prior art, the near-RT RIC is capable of interoperating with not just 5G but also 2G/3G/4G.

The all-G near-RT RIC may perform processing and network adjustments that are appropriate given the RAT. For example, a 4G/5G near-RT RIC performs network adjustments that are intended to operate in the 100 ms latency window. However, for 2G or 3G, these windows may be extended. As well, the all-G near-RT RIC can perform configuration changes that takes into account different network conditions across multiple RATs. For example, if 4G is becoming crowded or if compute is becoming unavailable, admission control, load shedding, or UE RAT reselection may be performed to redirect 4G voice users to use 2G instead of 4G, thereby maintaining performance for users. As well, the non-RT RIC is also changed to be a near-RT RIC, such that the all-G non-RT RIC is capable of performing network adjustments and configuration changes for individual RATs or across RATs similar to the all-G near-RT RIC. In some embodiments, each RAT can be supported using processes, that may be deployed in threads, containers, virtual machines, etc., and that are dedicated to that specific RAT, and, multiple RATs may be supported by combining them on a single architecture or (physical or virtual) machine. In some embodiments, the interfaces between different RAT processes may be standardized such that different RATs can be coordinated with each other, which may involve interwokring processes or which may involve supporting a subset of available commands for a RAT, in some embodiments.

FIG. 16 is a fourth schematic diagram of a multi-RAT RAN deployment architecture, in accordance with some embodiments. The multi-RAT CU protocol stack 701 is configured as shown and enables a multi-RAT CU-CP and multi-RAT CU-UP, performing RRC, PDCP, and SDAP for all-G. As well, some portion of the base station (DU or CU) may be in the cloud or on COTS hardware (O-Cloud), as shown. Coordination with SMO and the all-G near-RT RIC and the all-G non-RT RIC may be performed using the A1 and O2 function interfaces, as shown and elsewhere as specified by the ORAN and 3GPP interfaces for 4G/5G.

FIG. 17 is a fifth schematic diagram of a multi-RAT RAN deployment architecture, in accordance with some embodiments. This schematic diagram shows the use of the near/non-RT RIC to provide AI/ML (artificial intelligence and machine learning) policies and enrichment across Gs. This may also involve an SMO framework that is outside of the RAN, that is interfaced through the non-RT RIC, and may also involve an external system providing enrichment data to the SMO, as well as the core network and any services thereon, in some embodiments. The all-G Non-RT RIC serves as the integration point for performing network optimizations and adjustments that take into account any offline processes for AI/ML that involve adjustments that operate outside of the UE latency window (for 4G/5G ˜100 ms), in some embodiments.

FIG. 18 is a schematic diagram of a multi-RAT RAN deployment in operation, in accordance with some embodiments. Diagram 1901 is a schematic diagram of users in proximity to a variety of cells, labeled coverage cells and capacity cells. Coverage cells provide users with a connection to the network that is durable, typically located at a high tower; this type of connection may not, however, enable high bandwidth given the large number of users supported at such cells. Capacity cells support a smaller number of users and use different radio technologies to enable high throughput to users. Capacity and coverage cells are enabled to trade off users as needed to maintain the needs of the network and the users as well. The diagram shows that while there are several capacity cells available in the network, they are all turned off.

Diagram 1902 is a schematic diagram of the operator network, in accordance with some embodiments. A multi-RAT vBBU is in communication with a near-RT RIC and a non-RT RIC, as well as a Parallel Wireless element management system (EMS), which provides the system with awareness about active network nodes, as well as a MANO (OSS/BSS/NFVO) for network operational capabilities. The coverage and capacity cells shown in 1901 are in communication with the all-G near-RT RIC and all-G non-RT RIC. Network functions are managed by applications, called xApps when running on the near-RT RIC and rApps when running on the non-RT RIC, and these applications are in communication with each other and aware of the network conditions through information available at the systems on which they are running.

In operation, for some embodiments, for example, when a coverage cell is heavily loaded, an rApp on the non-RT RIC and an xApp on the near-RT RIC coordinate to identify a mitigation, which can include identifying an appropriate capacity cell to activate; activating the cell; and handing over users from the coverage cell to the newly active cell. In another example, in some embodiments, in the case that admission control is identified as causing too many users to be admitted to the network at the same time, throttling may be performed. Monitoring of network load and a subsequent instruction to perform throttling may be initiated at the near-RT RIC using an xApp, in some embodiments. This may be a multi-RAT activity and this may involve monitoring of network load for a first RAT and an instruction to perform throttling for a second RAT, in some embodiments.

FIG. 19 is a schematic diagram of an OpenRAN core architecture, in accordance with some embodiments. The present disclosure is enabled for use with the disclosed architecture in this figure. Various nodes, for example the CU-CP and CU-UP nodes (here marked O-CU-CP and O-CU-UP to denote OpenRAN-compatible nodes), use SCTP and may use the methods and systems described herein for SCTP high availability. The node marked “Infrastructure—COTS/White Box/Peripheral Hardware and Virtualization Layer” may, in some embodiments, use the containerized architecture described herein and may use SCTP high availability features to provide this functionality to any of the higher layers and nodes, e.g., O-XXX, Near-RT RIC, etc. of this architecture as shown in the figure, in some embodiments.

In any of the scenarios described herein, where processing may be performed at the cell, the processing may also be performed in coordination with a cloud coordination server. A mesh node may be an eNodeB. An eNodeB may be in communication with the cloud coordination server via an X2 protocol connection, or another connection. The eNodeB may perform inter-cell coordination via the cloud communication server, when other cells are in communication with the cloud coordination server. The eNodeB may communicate with the cloud coordination server to determine whether the UE has the ability to support a handover to Wi-Fi, e.g., in a heterogeneous network.

FIG. 20 shows a schematic diagram 100 of a CU-CP Open RAN architecture, in accordance with a 5G architecture. CU-CP 103 is in communication with a plurality of DUs 102, with one or more CU-UPs 104, service management and orchestration node (SMO) 101, and AMF/SMF 105. UPF 106 is also in communication with AMF/SMF and CU-UP.

FIG. 21 shows a CU-CP internal logical architecture and internal nodes shown as microservices, in accordance with some embodiments. A variety of microservices provide the benefits of a microservices-based architecture, such as massively parallel processing, restart and management and availability, advanced monitoring, etc. This microservices architecture enables 4G and 5G, as shown, and can be readily extended to 2G and 3G as well (not shown). All of these nodes can use microservices, in some embodiments. However, although a microservice architecture provides high availability and scalability for stateless services seamlessly, it is noted that a session created on SCTP association can be lost if one of the SCTP pods (microservices) crashes and existing connection are not restored in time-bound manner.

FIG. 22 is a schematic diagram of a microservice control architecture, in accordance with some embodiments. Shown is a schematic diagram showing a pod microservice logical architecture with front and back-end pods, in accordance with some embodiments. A plurality of front-end pods for terminating connections and back-end pods for handling and processing traffic is in communication with a database; the database handles registration of the pods as described below. Other nodes, such as peer nodes, interface with the microservice via a particular service IP, and routing is performed within the microservice to the front end pods and back end pods, in some embodiments by a routing pod. In some embodiments, an internal controller keeps track of health of some or all pods & micro services in a given namespace. As soon as any pod/container crashes, it updates the remaining pods. And takes necessary steps to bring system in workable state. In some embodiments, a database (Service registry) may act as service registry database for some or all pods and microservice in given namespace. All the pods on start-up can update required information in database & fetch required information from service registry database.

FIG. 23 is a schematic diagram of an SCTP microservice, in accordance with some embodiments. An active-active model is shown, wherein one microservice is the primary and another microservice is the backup, with both being active and the backup ready to take over at any time.

### Additional Embodiments

In any of the scenarios described herein, where processing may be performed at the cell, the processing may also be performed in coordination with a cloud coordination server. A mesh node may be an eNodeB. An eNodeB may be in communication with the cloud coordination server via an X2 protocol connection, or another connection. The eNodeB may perform inter-cell coordination via the cloud communication server when other cells are in communication with the cloud coordination server. The eNodeB may communicate with the cloud coordination server to determine whether the UE has the ability to support a handover to Wi-Fi, e.g., in a heterogeneous network.

Although the methods above are described as separate embodiments, one of skill in the art would understand that it would be possible and desirable to combine several of the above methods into a single embodiment, or to combine disparate methods into a single embodiment. For example, all of the above methods could be combined. In the scenarios where multiple embodiments are described, the methods could be combined in sequential order, or in various orders as necessary.

Although the above systems and methods are described in reference to 3GPP, one of skill in the art would understand that these systems and methods could be adapted for use with other wireless standards or versions thereof.

In some embodiments, the software needed for implementing the methods and procedures described herein may be implemented in a high level procedural or an object-oriented language such as C, C++, C#, Python, Java, or Perl. The software may also be implemented in assembly language if desired. Packet processing implemented in a network device can include any processing determined by the context. For example, packet processing may involve high-level data link control (HDLC) framing, header compression, and/or encryption. In some embodiments, software that, when executed, causes a device to perform the methods described herein may be stored on a computer-readable medium such as read-only memory (ROM), programmable-read-only memory (PROM), electrically crasable programmable-read-only memory (EEPROM), flash memory, or a magnetic disk that is readable by a general or special purpose-processing unit to perform the processes described in this document. The processors can include any microprocessor (single or multiple core), system on chip (SoC), microcontroller, digital signal processor (DSP), graphics processing unit (GPU), or any other integrated circuit capable of processing instructions such as an x86 or ARM microprocessor.

In some embodiments, the radio transceivers described herein may be base stations compatible with a Long Term Evolution (LTE) radio transmission protocol or air interface. The LTE-compatible base stations may be eNodeBs. In addition to supporting the LTE protocol, the base stations may also support other air interfaces, such as UMTS/HSPA, CDMA/CDMA2000, GSM/EDGE, GPRS, EVDO, other 3G/2G, 5G, legacy TDD, or other air interfaces used for mobile telephony. 5G core networks that are standalone or non-standalone have been considered by the inventors as supported by the present disclosure.

In some embodiments, the base stations described herein may support Wi-Fi air interfaces, which may include one or more of IEEE 802.11a/b/g/n/ac/af/p/h. In some embodiments, the base stations described herein may support IEEE 802.16 (WiMAX), to LTE transmissions in unlicensed frequency bands (e.g., LTE-U, Licensed Access or LA-LTE), to LTE transmissions using dynamic spectrum access (DSA), to radio transceivers for ZigBee, Bluetooth, or other radio frequency protocols including 5G, or other air interfaces.

The foregoing discussion discloses and describes merely exemplary embodiments of the present invention. In some embodiments, software that, when executed, causes a device to perform the methods described herein may be stored on a computer-readable medium such as a computer memory storage device, a hard disk, a flash drive, an optical disc, or the like. As will be understood by those skilled in the art, the present invention may be embodied in other specific forms without departing from the spirit or essential characteristics thereof. For example, wireless network topology can also apply to wired networks, optical networks, and the like. The methods may apply to LTE-compatible networks, to UMTS-compatible networks, to 5G networks, or to networks for additional protocols that utilize radio frequency data transmission. Various components in the devices described herein may be added, removed, split across different devices, combined onto a single device, or substituted with those having the same or similar functionality. Where the term “all-G” is used herein, it is understood to mean multi-RAT (having at least two radio access technologies).

Although the present disclosure has been described and illustrated in the foregoing example embodiments, it is understood that the present disclosure has been made only by way of example, and that numerous changes in the details of implementation of the disclosure may be made without departing from the spirit and scope of the disclosure, which is limited only by the claims which follow. Various components in the devices described herein may be added, removed, or substituted with those having the same or similar functionality. Various steps as described in the figures and specification may be added or removed from the processes described herein, and the steps described may be performed in an alternative order, consistent with the spirit of the invention. Features of one embodiment may be used in another embodiment.

The foregoing discussion discloses and describes merely exemplary embodiments of the present invention. In some embodiments, software that, when executed, causes a device to perform the methods described herein may be stored on a computer-readable medium such as a computer memory storage device, a hard disk, a flash drive, an optical disc, or the like. As will be understood by those skilled in the art, the present invention may be embodied in other specific forms without departing from the spirit or essential characteristics thereof. For example, wireless network topology can also apply to wired networks, optical networks, and the like. The methods may apply to LTE-compatible networks, to UMTS-compatible networks, to 5G networks, or to networks for additional protocols that utilize radio frequency data transmission. Various components in the devices described herein may be added, removed, split across different devices, combined onto a single device, or substituted with those having the same or similar functionality.

Although the present disclosure has been described and illustrated in the foregoing example embodiments, it is understood that the present disclosure has been made only by way of example, and that numerous changes in the details of implementation of the disclosure may be made without departing from the spirit and scope of the disclosure, which is limited only by the claims which follow. Various components in the devices described herein may be added, removed, or substituted with those having the same or similar functionality. Various steps as described in the figures and specification may be added or removed from the processes described herein, and the steps described may be performed in an alternative order, consistent with the spirit of the invention. Features of one embodiment may be used in another embodiment. Other embodiments are within the following claims.

This application hereby incorporates by reference in their entirety for all purposes the U.S. patent application having internal docket number PWS-72814US00, filed Feb. 11, 2023 under U.S. provisional patent application No. 63/484,485 and titled “Cluster level approach for RAN user scheduling”; the U.S. patent application having internal docket number PWS-72815US00, filed Feb. 17, 2023 under U.S. provisional patent application No. 63/485,790 and titled “Dynamic latency compensation and packet security for RAN transport”; the U.S. patent application having internal docket number PWS-72816US00, filed Feb. 27, 2023 under U.S. provisional patent application No. 63/487,245 and titled “Cluster level approach for RAN user scheduling”; the U.S. patent application having internal docket number PWS-72818US00, U.S. provisional patent application No. 63/493,599, filed Mar. 31, 2023, and titled “Cluster Level Approach for RAN Application Redundancy and Resiliency”; the U.S. patent application having internal docket number PWS-72771US00, titled “Coherence Time-Based Scheduling”.

In some embodiments, one or more network functions as described herein may be provided by virtualized servers, which may be provided using containerization technology. Containers decouple applications from underlying host infrastructure. This makes deployment casier in different cloud or OS environments. A container image is a ready-to-run software package, containing everything needed to run an application: the code and any runtime it requires, application and system libraries, and default values for any essential settings. Containers may include the use of Kubernetes or other container runtimes.

In Kubernetes, A pod (as in a pod of whales or pea pod) is a group of one or more containers, with shared storage and network resources, and a specification for how to run the containers. A Pod's contents are always co-located and co-scheduled, and run in a shared context. A Pod models an application-specific “logical host”: it contains one or more application containers which are relatively tightly coupled. In non-cloud contexts, applications executed on the same physical or virtual machine are analogous to cloud applications executed on the same logical host. Pods are configured in Kubernetes using YAML files.

For example, a controller for a given resource provided using containers handles replication and rollout and automatic healing in case of Pod failure. For example, if a Node fails, a controller notices that Pods on that Node have stopped working and creates a replacement Pod. The scheduler places the replacement Pod onto a healthy Node.

The use of containerized technologies is rapidly spreading for providing 5G core (5GC) technologies. The present disclosure is deployed using containerized technologies, in some embodiments.

Further details regarding some embodiments may be found in U.S. Pat. App. Publication Nos. US20200045565A1 and US20200042365A1, each of which are hereby incorporated by reference in their entirety for all purposes.

This application also incorporates by reference the U.S. patent application having docket number PWS-72749US01, filed 2022 Aug. 16 with application Ser. No. 17/819,950 and title “4G/5G Open RAN CU-UP High Availability Solution”; the U.S. patent application having docket number PWS-72754US01, filed 2022 Dec. 19 with application Ser. No. 18/068,520 and title “CU-CP High Availability”; and the U.S. patent application having docket number PWS-72765US01, filed 2022 Dec. 29 with application Ser. No. 18/148,432 and title “Singleton Microservice High Availability.”

Where virtualization is described herein, one having skill in the cloud technology arts would understand that a variety of technologies could be used to provide virtualization, including one or more of the following: containers, Kubernetes, Docker, hypervisors, virtual machines, hardware virtualization, microservices, AWS, Azure, etc. In a preferred embodiment, containerized microservices coordinated using Kubernetes are used to provide baseband processing for multiple RATs as deployed on the tower.

Open RAN is the movement in wireless telecommunications to disaggregate hardware and software and to create open interfaces between them. Open RAN also disaggregates RAN from into components like RRH (Remote Radio Head), DU (Distributed Unit), CU (Centralized Unit), Near-RT (Real-Time) and Non-RT (Real-Time) RIC (RAN Intelligence Controller). Below is the Open RAN architecture as defined by ORAN alliance.

CU function is split into CU-CP (Control Plane) and CU-UP (User Plane) function to provide Control and User Plane separation. Open RAN solution needs to support: Open Interfaces between different functions; Software based functions; Cloud Native functions; Intelligence support via support for xApps/rApps; 3rd Party RRHs; Disaggregated functions; White Box COTS hardware support; and Data Path separated from Control plane traffic.

Abbreviations used in this disclosure:

CU-CP: This node handles RRC and the control plane part of the PDCP protocol. This node communicates with DU over F1-C interface and with CU-UP over E1 interface as defined in 3GPP specifications.

CU-UP/s: This node handles user plane part of PDCP protocol and SDAP protocol. It communicates with CU-CP over E1 interface and with DU over F1-U interface.

SMO (Service management and orchestration): control of infra structure component like CPU/Memory and scale up and scale down operations.

FCAPS (Fault, Configuration, Security, Performance, Accounting) management of Open-RAN elements (gNB-CU-CP, gNB-CU-UP, gNB-DU).

AMF/SMF: 3GPP defined 5G core network element for control signaling.

UPF: 3GPP defined 5G core network element for data-plane traffic.

DU (gNB-DU): 3GPP defined 5G access network element.

FIG. 1 is a schematic diagram of a legacy RAN deployment architecture, as known in the prior art. Radio tower 101 is used for co-locating a 2G base station 102, 3G base station 103, 4G base station 104, and 5G base station 105, each individual RAT base station having its own radio(s) and processing. To support and enable the radios to perform their necessary functions, including PHY, MAC, backhaul, RRC, etc., several base band units (BBUs) 106 are typically located at the base of the tower and are connected to the individual RAT base stations using a physical cable. This cable itself introduces signal loss and heat/power wastage. The BBUs themselves are expensive to purchase and deploy to the site, are expensive to operate given their need for real estate, HVAC and electrical support, and are expensive also to maintain, as a typical maintenance activity requires a dedicated truck roll to the site with a skilled technician.

### Radio Unit Functional Splits

FIG. 2 shows a schematic diagram of radio functional splits showing split 7.2X RU as well as other splits. The use of these functional splits is encouraged by ORAN.

5G New Radio (NR) was designed to allow for disaggregating the baseband unit (BBU) by breaking off functions beyond the Radio Unit (RU) into Distributed Units (DUs) and Centralized Units (CUs), which is called a functional split architecture. This concept has been extended to 4G as well.

RU: This is the radio hardware unit that coverts radio signals sent to and from the antenna into a digital signal for transmission over packet networks. It handles the digital front end (DFE) and the lower PHY layer, as well as the digital beamforming functionality. 5G RU designs are supposed to be inherently intelligent, but the key considerations of RU design are size, weight, and power consumption. Deployed on site.

DU: The distributed unit software that is deployed on site on a COTS server. DU software is normally deployed close to the RU on site and it runs the RLC, MAC, and parts of the PHY layer. This logical node includes a subset of the eNodeB (NB)/gNodeB (gNB) functions, depending on the functional split option, and its operation is controlled by the CU.

CU: The centralized unit software that runs the Radio Resource Control (RRC) and Packet Data Convergence Protocol (PDCP) layers. The gNB consists of a CU and one DU connected to the CU via Fs-C and Fs-U interfaces for CP and UP respectively. A CU with multiple DUs will support multiple gNBs. The split architecture lets a 5G network utilize different distributions of protocol stacks between CU and DUs depending on midhaul availability and network design. It is a logical node that includes the gNB functions like transfer of user data, mobility control, RAN sharing (MORAN), positioning, session management etc., except for functions that are allocated exclusively to the DU. The CU controls the operation of several DUs over the midhaul interface. CU software can be co-located with DU software on the same server on site.

When the RAN functional split architecture (FIG. 4) is fully virtualized, CU and DU functions runs as virtual software functions on standard commercial off-the-shelf (COTS) hardware and be deployed in any RAN tiered datacenter, limited by bandwidth and latency constraints.

Option 7.2 (shown) is the functional split chosen by the O-RAN Alliance for 4G and 5G. It is a low-level split for ultra-reliable low-latency communication (URLLC) and near-edge deployment. RU and DU are connected by the eCPRI interface with a latency of ˜100 microseconds. In O-RAN terminology, RU is denoted as O-RU and DU is denoted as O-DU. Further information is available in US20200128414A1, hereby incorporated by reference in its entirety.

FIG. 3 is a schematic diagram of an Open RAN 4G/5G deployment architecture, as known in the prior art. The O-RAN deployment architecture includes an O-DU and O-RU, as described above with respect to FIG. 2, which together comprise a 5G base station in the diagram as shown. The O-CU-CP (central unit control plane) and O-CU-UP (central unit user plane) are ORAN-aware 5G core network nodes. An ORAN-aware LTE node, O-eNB, is also shown. As well, a near-real time RAN intelligent controller is shown, in communication with the CU-UP, CU-CP, and DU, performing near-real time coordination As well, a non-real time RAN intelligent controller is shown, receiving inputs from throughout the network and specifically from the near-RT RIC and performing service management and orchestration (SMO), in coordination with the operator's network (not shown). Absent from the ORAN network concept is any integration of 2G, 3G. Also absent is any integration of a 2G/3G/4G DU or RU.

FIG. 4 is a first schematic diagram of a multi-RAT RAN deployment architecture, in accordance with some embodiments. FIG. 4 shows a radio tower with a remote radio head (RRH) supporting multiple RATs, 2G/3G/4G/5G, but without requiring four generations of radio base stations as shown in FIG. 1. Instead, one or more software-upgradable, remotely configurable base stations is coupled to radio heads and filters that are able to operate on the appropriate frequencies for 2G, 3G, 4G, and 5G RATs. The multiple BBUs located at the bottom of the tower in FIG. 1 have been replaced with one or more vBBUs, baseband units that are rearchitected to use modern virtualization technologies. FIG. 4 can be enabled using a technology like CPRI or eCPRI, which enables digitization and transfer of radio I/Q samples for further processing at a BBU or vBBU.

Where virtualization is described herein, one having skill in the cloud technology arts would understand that a variety of technologies could be used to provide virtualization, including one or more of the following: containers, Kubernetes, Docker, hypervisors, virtual machines, hardware virtualization, microservices, AWS, Azure, etc. In a preferred embodiment, containerized microservices coordinated using Kubernetes are used to provide baseband processing for multiple RATs as deployed on the tower.

The inventors have appreciated that the use of the 3GPP model for functional splits is flexible and may be used to provide deployment flexibility for multiple RATs, not just 5G. Functional splits can be used in conjunction with cloud and virtualization technology to perform virtualization of, e.g., the RU, DU, and CU of not just 5G but also 4G, 3G, 2G, etc. This enables the use of commodity off-the-shelf servers, software-defined networking that can be rapidly upgraded remotely, and lower power requirements by using modern hardware compared to legacy hardware.

FIG. 5 is a second schematic diagram of a multi-RAT RAN deployment architecture, in accordance with some embodiments. As shown, a single RRH supports a 5G RAT with an Option 7.2 split, a 4G RAT with an Option 7.2 split, and 2G+3G with an Option 8 split. With the Option 7.2 split, the PHY is split into High PHY and Low PHY. For option 7-2, the uplink (UL), CP removal, fast Fourier transform (FFT), digital beamforming (if applicable), and prefiltering (for PRACH (Physical Random Access Channel) only) functions all occur in the RU. The rest of the PHY is processed in the DU. For the downlink (DL), the inverse FFT (IFFT), CP addition, precoding functions, and digital beamforming (if applicable) occur in the RU, and the rest of the PHY processing happens in the DU. This is the preferred ORAN split for 5G, and can also be used for 4G. For 2G+3G, an Option 8 split is preferred, where only RF will be performed at the RU and further processing (PHY/MAC/RLC/PDCP) is performed at the vBBU. This is desirable because the processing and latency requirements for 2G and 3G are lower, and are readily fulfilled by a BBU or VBBU.

Continuing with FIG. 5, a fronthaul link connects the RRH to a DU+CU, which runs a variety of virtualized RAT processing on a vBBU machine. The fronthaul link may be CPRI or eCPRI, or another similar interface. The DU+CU may be located at the base of the tower or at a further remove as enabled by different latency envelopes; typically this will be close to the tower for a 5G deployment. In some embodiments, a HetNet Gateway (HNG), which performs control and user plane data aggregation and gateway services, may be the next destination via the backhaul connection; the HNG may disaggregate the different RAT communications to be directed to different RAT cores (i.e., a 2G core, a 3G core, a 4G core, a 5G core and so on). In some embodiments and in certain situations, an HNG may perform virtualization or interworking of aggregated communications such that, e.g., 2G communications may be interworked to 4G IP voice communications and routed through the 4G core. In some embodiments, the HNG may perform virtualization of one or more cores such that the communications may not need to terminate at a RAT-specific core; this feature may be combined with interworking in some embodiments. In some embodiments, no aggregator may be present and the vBBU may directly route communications to each RAT's individual core.

FIG. 6 is a schematic diagram of a multi-RAT RAN deployment architecture, in accordance with some embodiments. Multiple generations of UE are shown, connecting to RRHs that are coupled via fronthaul to an all-G Parallel Wireless DU. The all-G DU is capable of interoperating with an all-G CU-CP and an all-G CU-UP. Backhaul may connect to the operator core network, in some embodiments, which may include a 2G/3G/4G packet core, EPC, HLR/HSS, PCRF, AAA, etc., and/or a 5G core. In some embodiments an all-G near-RT RIC is coupled to the all-G DU and all-G CU-UP and all-G CU-CP. Unlike in the prior art, the near-RT RIC is capable of interoperating with not just 5G but also 2G/3G/4G.

The all-G near-RT RIC may perform processing and network adjustments that are appropriate given the RAT. For example, a 4G/5G near-RT RIC performs network adjustments that are intended to operate in the 100 ms latency window. However, for 2G or 3G, these windows may be extended. As well, the all-G near-RT RIC can perform configuration changes that takes into account different network conditions across multiple RATs. For example, if 4G is becoming crowded or if compute is becoming unavailable, admission control, load shedding, or UE RAT reselection may be performed to redirect 4G voice users to use 2G instead of 4G, thereby maintaining performance for users. As well, the non-RT RIC is also changed to be a near-RT RIC, such that the all-G non-RT RIC is capable of performing network adjustments and configuration changes for individual RATs or across RATs similar to the all-G near-RT RIC. In some embodiments, each RAT can be supported using processes, that may be deployed in threads, containers, virtual machines, etc., and that are dedicated to that specific RAT, and, multiple RATs may be supported by combining them on a single architecture or (physical or virtual) machine. In some embodiments, the interfaces between different RAT processes may be standardized such that different RATs can be coordinated with each other, which may involve interworking processes or which may involve supporting a subset of available commands for a RAT, in some embodiments.

Open Radio Access Network (Open RAN) is a movement in wireless telecommunications to disaggregate hardware and software and to create open interfaces between them. Open RAN also disaggregates RAN from into components like RRH (Remote Radio Head), DU (Distributed Unit), CU (Centralized Unit), Near-RT (Real-Time) and Non-RT (Real-Time) RIC (RAN Intelligence Controller). Open RAN has published specifications for the 4G and 5G radio access technologies (RATs).

The first RAT may be 4G or 5G, and The radio fronthaul interface may be Common Public Radio Interface (CPRI) or Enhanced Common Public Radio Interface (eCPRI). The second RAT may be 2G or 3G, and The radio fronthaul interface may be Common Public Radio Interface (CPRI) or Enhanced Common Public Radio Interface (eCPRI). The first and the second functional RU may be colocated on a single physical device and virtualized to operate as separate processes. The first and the second functional RU may be instantiated as virtualized containers.

The multi-RAT non-RT RIC may be coupled to a network operator service management and orchestration (SMO) functionality. The method may further comprise a multi-RAT central unit control plane (CU-CP) and multi-RAT central unit user plane (CU-UP).

Multiple generations of UE are shown, connecting to RRHs that are coupled via fronthaul to an all-G Parallel Wireless DU. The all-G DU is capable of interoperating with an all-G CU-CP and an all-G CU-UP. Backhaul may connect to the operator core network, in some embodiments, which may include a 2G/3G/4G packet core, EPC, HLR/HSS, PCRF, AAA, etc., and/or a 5G core. In some embodiments an all-G near-RT RIC is coupled to the all-G DU and all-G CU-UP and all-G CU-CP. Unlike in the prior art, the near-RT RIC is capable of interoperating with not just 5G but also 2G/3G/4G.

FIG. 7 is a fourth schematic diagram of a multi-RAT RAN deployment architecture, in accordance with some embodiments. The multi-RAT CU protocol stack 701 is configured as shown and enables a multi-RAT CU-CP and multi-RAT CU-UP, performing RRC, PDCP, and SDAP for all-G. As well, some portion of the base station (DU or CU) may be in the cloud or on COTS hardware (O-Cloud), as shown. Coordination with SMO and the all-G near-RT RIC and the all-G non-RT RIC may be performed using the A1 and O2 function interfaces, as shown and elsewhere as specified by the ORAN and 3GPP interfaces for 4G/5G.

FIG. 8 is a fifth schematic diagram of a multi-RAT RAN deployment architecture, in accordance with some embodiments. This schematic diagram shows the use of the near/non-RT RIC to provide AI/ML (artificial intelligence and machine learning) policies and enrichment across Gs. This may also involve an SMO framework that is outside of the RAN, that is interfaced through the non-RT RIC, and may also involve an external system providing enrichment data to the SMO, as well as the core network and any services thereon, in some embodiments. The all-G Non-RT RIC serves as the integration point for performing network optimizations and adjustments that take into account any offline processes for AI/ML that involve adjustments that operate outside of the UE latency window (for 4G/5G ˜100 ms), in some embodiments.

FIG. 9 is a schematic diagram of a multi-RAT RAN deployment in operation, in accordance with some embodiments. Diagram 901 is a schematic diagram of users in proximity to a variety of cells, labeled coverage cells and capacity cells. Coverage cells provide users with a connection to the network that is durable, typically located at a high tower; this type of connection may not, however, enable high bandwidth given the large number of users supported at such cells. Capacity cells support a smaller number of users and use different radio technologies to enable high throughput to users. Capacity and coverage cells are enabled to trade off users as needed to maintain the needs of the network and the users as well. The diagram shows that while there are several capacity cells available in the network, they are all turned off.

Diagram 902 is a schematic diagram of the operator network, in accordance with some embodiments. A multi-RAT vBBU is in communication with a near-RT RIC and a non-RT RIC, as well as a Parallel Wireless element management system (EMS), which provides the system with awareness about active network nodes, as well as a MANO (OSS/BSS/NFVO) for network operational capabilities. The coverage and capacity cells shown in 901 are in communication with the all-G near-RT RIC and all-G non-RT RIC. Network functions are managed by applications, called xApps when running on the near-RT RIC and rApps when running on the non-RT RIC, and these applications are in communication with each other and aware of the network conditions through information available at the systems on which they are running.

In operation, for some embodiments, for example, when a coverage cell is heavily loaded, an rApp on the non-RT RIC and an xApp on the near-RT RIC coordinate to identify a mitigation, which can include identifying an appropriate capacity cell to activate; activating the cell; and handing over users from the coverage cell to the newly active cell. In another example, in some embodiments, in the case that admission control is identified as causing too many users to be admitted to the network at the same time, throttling may be performed. Monitoring of network load and a subsequent instruction to perform throttling may be initiated at the near-RT RIC using an xApp, in some embodiments. This may be a multi-RAT activity and this may involve monitoring of network load for a first RAT and an instruction to perform throttling for a second RAT, in some embodiments.

FIG. 10 is a schematic diagram of an OpenRAN core architecture, in accordance with some embodiments. The present disclosure is enabled for use with the disclosed architecture in this figure. Various nodes, for example the CU-CP and CU-UP nodes (here marked O-CU-CP and O-CU-UP to denote OpenRAN-compatible nodes), use SCTP and may use the methods and systems described herein for SCTP high availability. The node marked “Infrastructure-COTS/White Box/Peripheral Hardware and Virtualization Layer” may, in some embodiments, use the containerized architecture described herein and may use SCTP high availability features to provide this functionality to any of the higher layers and nodes, e.g., O-XXX, Near-RT RIC, etc. of this architecture as shown in the figure, in some embodiments.

FIG. 11 shows a schematic diagram 1100 of a CU-CP Open RAN architecture, in accordance with a 5G architecture. CU-CP 1103 is in communication with a plurality of DUs 1102, with one or more CU-UPs 1104, service management and orchestration node (SMO) 1101, and AMF/SMF 1105. UPF 1106 is also in communication with AMF/SMF and CU-UP.

FIG. 12 shows a CU-CP internal logical architecture and internal nodes shown as microservices, in accordance with some embodiments. A variety of microservices provide the benefits of a microservices-based architecture, such as massively parallel processing, restart and management and availability, advanced monitoring, etc. This microservices architecture enables 4G and 5G, as shown, and can be readily extended to 2G and 3G as well (not shown). All of these nodes can use microservices, in some embodiments. However, although a microservice architecture provides high availability and scalability for stateless services seamlessly, it is noted that a session created on SCTP association can be lost if one of the SCTP pods (microservices) crashes and existing connection are not restored in time-bound manner.

FIG. 13 is a schematic diagram of a microservice control architecture, in accordance with some embodiments. Shown is a schematic diagram showing a pod microservice logical architecture with front and back-end pods, in accordance with some embodiments. A plurality of front-end pods for terminating connections and back-end pods for handling and processing traffic is in communication with a database; the database handles registration of the pods as described below. Other nodes, such as peer nodes, interface with the microservice via a particular service IP, and routing is performed within the microservice to the front end pods and back end pods, in some embodiments by a routing pod.

In some embodiments, an internal controller keeps track of health of some or all pods & micro services in a given namespace. As soon as any pod/container crashes, it updates the remaining pods. And takes necessary steps to bring system in workable state.

In some embodiments, a database (Service registry) may act as service registry database for some or all pods and microservice in given namespace. All the pods on start-up can update required information in database & fetch required information from service registry database.

The disclosed high availability solution is intended to enhance availability of a single pod solution, as follows. In Kubernetes, a Pod (as in a pod of whales or pea pod) is a group of one or more containers, with shared storage and network resources, and a specification for how to run the containers. A Pod's contents may be co-located and co-scheduled, and run in a shared context. A Pod models an application-specific “logical host”: it contains one or more application containers which are relatively tightly coupled. In non-cloud contexts, applications executed on the same physical or virtual machine are analogous to cloud applications executed on the same logical host. Pods get their own IP and services get a cluster IP. Cluster IP is internal only. Kubernetes creates a cluster when a pod is created. Kubernetes supports a method for tracking which pods are available and/or down. It tracks which ones are live and which ones are down. While Kubernetes is described herein, other container management and orchestration methods are understood to be supported in the spirit of the present disclosure.

Pods are configured in Kubernetes using YAML files. A controller for the resource handles replication and rollout and automatic healing in case of Pod failure. For example, if a Node fails, a controller notices that Pods on that Node have stopped working and creates a replacement Pod. The scheduler places the replacement Pod onto a healthy Node.

In telecom, it is desirable to have a single controller running at a single time, not multiple controllers. This is because there are often situations where state is required to be kept at the service provider. This results in a single controller being visible, and, standby controller being invisible to others. However, Kubernetes does not have any concept of active and standby, and this concept is facilitated by the addition of labels or selectors as follows.

There are a variety of other higher-layer protocols and interfaces, such as F1, E1, Xn/X2, NGAP. No higher layer communication or change to these higher-layer protocols is needed to provide HA specifically for these. But since these protocols are implemented on top of SCTP, this approach also provides HA for these higher-layer protocols as well. Any protocols that sit on top of SCTP or using SCTP as a transport would be enabled with HA using this mechanism, in some embodiments. This would apply to 2G, 3G, 4G, 5G, or any other SCTP-reliant protocol.

FIG. 14 is a schematic diagram of an SCTP microservice, in accordance with some embodiments. An active-active model is shown, wherein one microservice is the primary and another microservice is the backup, with both being active and the backup ready to take over at any time.

Since any new SCTP connection will be given to any of the pods of SCTP-microservice, and one SCTP connection/association will be terminated on one of SCTP pod only and further traffic related to that association will flow via this connection/association only, each SCTP pod is over provisioned with additional active pods to handle additional load/connection if any of the pods is to fail, as shown. This provides high availability.

### Additional Embodiments

In any of the scenarios described herein, where processing may be performed at the cell, the processing may also be performed in coordination with a cloud coordination server. A mesh node may be an eNodeB. An eNodeB may be in communication with the cloud coordination server via an X2 protocol connection, or another connection. The eNodeB may perform inter-cell coordination via the cloud communication server when other cells are in communication with the cloud coordination server. The eNodeB may communicate with the cloud coordination server to determine whether the UE has the ability to support a handover to Wi-Fi, e.g., in a heterogeneous network.

Although the methods above are described as separate embodiments, one of skill in the art would understand that it would be possible and desirable to combine several of the above methods into a single embodiment, or to combine disparate methods into a single embodiment. For example, all of the above methods could be combined. In the scenarios where multiple embodiments are described, the methods could be combined in sequential order, or in various orders as necessary.

Although the above systems and methods are described in reference to 3GPP, one of skill in the art would understand that these systems and methods could be adapted for use with other wireless standards or versions thereof.

In some embodiments, the software needed for implementing the methods and procedures described herein may be implemented in a high level procedural or an object-oriented language such as C, C++, C#, Python, Java, or Perl. The software may also be implemented in assembly language if desired. Packet processing implemented in a network device can include any processing determined by the context. For example, packet processing may involve high-level data link control (HDLC) framing, header compression, and/or encryption. In some embodiments, software that, when executed, causes a device to perform the methods described herein may be stored on a computer-readable medium such as read-only memory (ROM), programmable-read-only memory (PROM), electrically erasable programmable-read-only memory (EEPROM), flash memory, or a magnetic disk that is readable by a general or special purpose-processing unit to perform the processes described in this document. The processors can include any microprocessor (single or multiple core), system on chip (SoC), microcontroller, digital signal processor (DSP), graphics processing unit (GPU), or any other integrated circuit capable of processing instructions such as an x86 or ARM microprocessor.

In some embodiments, the radio transceivers described herein may be base stations compatible with a Long Term Evolution (LTE) radio transmission protocol or air interface. The LTE-compatible base stations may be eNodeBs. In addition to supporting the LTE protocol, the base stations may also support other air interfaces, such as UMTS/HSPA, CDMA/CDMA2000, GSM/EDGE, GPRS, EVDO, other 3G/2G, 5G, legacy TDD, or other air interfaces used for mobile telephony. 5G core networks that are standalone or non-standalone have been considered by the inventors as supported by the present disclosure.

In some embodiments, the base stations described herein may support Wi-Fi air interfaces, which may include one or more of IEEE 802.11a/b/g/n/ac/af/p/h. In some embodiments, the base stations described herein may support IEEE 802.16 (WiMAX), to LTE transmissions in unlicensed frequency bands (e.g., LTE-U, Licensed Access or LA-LTE), to LTE transmissions using dynamic spectrum access (DSA), to radio transceivers for ZigBee, Bluetooth, or other radio frequency protocols including 5G, or other air interfaces.

The foregoing discussion discloses and describes merely exemplary embodiments of the present invention. In some embodiments, software that, when executed, causes a device to perform the methods described herein may be stored on a computer-readable medium such as a computer memory storage device, a hard disk, a flash drive, an optical disc, or the like. As will be understood by those skilled in the art, the present invention may be embodied in other specific forms without departing from the spirit or essential characteristics thereof. For example, wireless network topology can also apply to wired networks, optical networks, and the like. The methods may apply to LTE-compatible networks, to UMTS-compatible networks, to 5G networks, or to networks for additional protocols that utilize radio frequency data transmission. Various components in the devices described herein may be added, removed, split across different devices, combined onto a single device, or substituted with those having the same or similar functionality. Where the term “all-G” is used herein, it is understood to mean multi-RAT (having at least two radio access technologies).

Although the present disclosure has been described and illustrated in the foregoing example embodiments, it is understood that the present disclosure has been made only by way of example, and that numerous changes in the details of implementation of the disclosure may be made without departing from the spirit and scope of the disclosure. Various components in the devices described herein may be added, removed, or substituted with those having the same or similar functionality. Features of one embodiment may be used in another embodiment. Various steps as described in the figures and specification may be added or removed from the processes described herein, and the steps described may be performed in an alternative order, consistent with the spirit of the invention and the following claims.

1. A method for network agility traffic steering at a centralized management entity in a network system, the method comprising:
receiving load management information from a plurality of cells within a network cluster;
evaluating the load management information to determine resource allocation for the plurality of cells within the network cluster;
generating traffic steering instructions based on the evaluation;
transmitting the traffic steering instructions to the cells within the network cluster to dynamically adjust resource allocation and network performance; and
enabling clustering of cells through containerized microservices coordinated using Kubernetes, allowing for flexible and scalable deployment of network functions.

2. The method of claim 1, wherein the network cluster is configured to utilize low-latency backhaul connections, such as eCPRI, to ensure rapid communication between the centralized management entity and the cells within the cluster.

3. The method of claim 1, wherein the centralized management entity further takes into account the signal strength of the different cells as seen from user equipment (UE) to enhance the accuracy of traffic steering decisions.

4. The method of claim 1, wherein the centralized management entity is implemented using a near-real-time RAN Intelligent Controller (RIC) capable of handling multi-RAT environments.

5. The method of claim 1, wherein the centralized management entity provides network agility traffic steering in a multi-RAT (Radio Access Technology) environment.

6. The method of claim 1, wherein the cells operate on different RATs including at least 4G and 5G.

7. The method of claim 1, wherein the instructions are applicable to at least two of Option 7.2, Option 6, and Option 8 radio fronthaul splits.

8. The method of claim 1, wherein the centralized management entity performs decision-making that takes into account energy savings by steering traffic to a smaller number of carriers, thereby reducing the number of active carriers at a given time.

9. The method of claim 1, wherein the centralized management entity provides resource allocation for at least two of 2G, 4G, and 5G.

10. The method of claim 1, wherein the network system performs proactive load balancing by rebalancing an entire cluster when a certain load threshold is reached, rather than waiting for a single cell to reach its maximum load.

11. The method of claim 1, wherein the network system integrates AI/ML policies and enrichment across different generations (Gs) to optimize network performance.

12. The method of claim 1, wherein the network system uses a microservices-based architecture for high availability and scalability, enabling parallel processing and advanced monitoring.
